(19) United States
(12) Patent Application Publication
(10) Pub. No.: US 2024/0097228 A1
(43) Pub. Date: Mar. 21, 2024

(54) DIRECT RECYCLING AND RECOVERY METHOD OF CATHODE MATERIALS FROM SPENT LITHIUM ION BATTERIES

(71) Applicant: CASE WESTERN RESERVE UNIVERSITY, Cleveland, OH (US)

(72) Inventors: Yu Wang, Cleveland, OH (US); Chris Yingchun Yuan, Solon, OH (US)

(21) Appl. No.: 18/467,820

(22) Filed: Sep. 15, 2023

Related U.S. Application Data
(63) Continuation of application No. 63/375,735, filed on Sep. 15, 2022.

(51) Int. Cl. H01M 10/54; H01M 4/04

(52) U.S. Cl. CPC H01M 10/54; H01M 4/0471; H01M 4/049; H01M 2004/028

(57) ABSTRACT

A method of relithiating a spent cathode material from a spent lithium ion battery includes mixing the spent lithium cathode material with a particulate lithium source and heating the mixture to a temperature effective to sinter the mixture and relithiate the spent lithium cathode material.

### RELATED APPLICATION

This application claims priority from U.S. Provisional Application No. 63/375,735, filed Sep. 15, 2022, the subject matter of which is incorporated herein by reference in its entirety.

### GOVERNMENT FUNDING

This invention was made with government support under 2101129 awarded by the National Science Foundation. The government has certain rights in the invention.

### BACKGROUND

Lithium ion battery is now popularly used in portable electronic devices and electric vehicles. Since the battery life of electric vehicles is only a few years, a large amount of lithium ion batteries are reaching their end of life. By the end of 2020, 17.7 GWh of lithium ion batteries had reached the end of life, which equals around 20000 tons of cathode materials. It is estimated that this figure will be increased to more than 140 GWh by 2035. In the fabrication of lithium ion batteries, the cost of cathode materials contributes approximately 32.7% of the total cost. Recycling and reusing the cathode materials from spent lithium ion batteries is promising in reducing the cost of lithium ion batteries and mitigate their environmental impacts. However, recent battery recycling efforts offered a low recovery rate of cathode active material while consuming unsustainable energy and metals. By 2021, the recycling rate of the cathode active material is still low at under 5%. Thus, recycling and recovery technologies of cathode active materials are in urgent needs for further lowering the cost of lithium ion batteries, reducing the use of rare-earth metals, and mitigating the environmental impacts.

Current recycling technologies for spent lithium ion batteries are grouped into hydrometallurgy, pyrometallurgy, and direct recycling. Pyrometallurgical recycling smelts the end-of-life battery materials and recovers some of the useful metals in alloy forms through multistep purification and separation processes. The hydrometallurgical process utilizes acid leaching and solvent extraction and recovers lithium as Li₂CO₃ and other major materials as polymetallic compounds. While direct recycling recovers the capacity, structure, and morphology of spent cathode active materials without destroying the original structure and yields the reusable high-value materials to the battery industries.

### BRIEF DESCRIPTION OF THE DRAWINGS

FIG. 1 is a flow chart illustrating a method of relithiating a spent cathode material from a spent lithium ion battery.

FIG. 2 illustrates a method of recycling and/or recovery of cathode materials from a spent lithium ion battery in accordance with another embodiment described herein.

FIG. 3 is a flowchart of the direct recycling method.

FIG. 4 illustrates cycling performance of degraded, relithiated, and pristine LMO/NMC cathode.

FIG. 5 illustrates long-term cycling performance of relithiated LMO/NMC cathode.

FIG. 6 illustrates rate capability results of degraded and relithiated LMO/NMC cathode.

FIG. 7 illustrates the discharge capacity of recycled LMO/NMC half cell (coin).

FIG. 8 illustrates difference and degradation in pristine material vs. recycled material.

FIG. 9 illustrates the voltage vs. discharge specific capacity in the recycled batteries.

### DETAILED DESCRIPTION

Embodiments described herein relate to a direct recycling method to recover battery cathode materials from spent lithium ion batteries and reuse them in the manufacturing of new lithium ion batteries. We designed a novel direct recycling method to recover the structure and capacity of cathode active materials from spent lithium ion batteries without the high-temperature annealing process and can reuse the relithiated active material in the manufacturing of lithium ion batteries. This method only requires one heating process in the air, which consists of a preheating step to activate the materials and a sintering step to relithiate the materials at moderate temperatures. The performance of the recovered and relithiated cathode active materials can be as good as those of pristine materials. The relithiated materials also possess an outstanding rate capability.

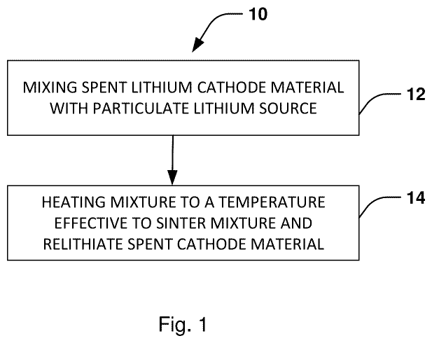

FIG. 1 is a flow chart that illustrates a method 10 of relithiating a spent cathode material from a spent lithium ion battery. The method 10 at step 12 include mixing the spent lithium cathode material with a particulate lithium source. At step 14, the mixture is heated to a temperature effective to sinter the mixture and relithiate the spent lithium cathode material.

In some embodiments, the mixture is preheated to a temperature below the sintering temperature prior sintering.

In some embodiments, the mixture can be preheated at a temperature of about 140° C. to about 160° C. for a first duration of time and sintered at a temperature of about 300° C. to about 350° C. for a second duration of time. The second duration of time can be substantially longer than the first duration of time.

In some embodiments, the relithiated cathode material can be milled after sintering to prevent agglomeration.

In other embodiments, the method can further include separating relithiated cathode material from the mixture.

In some embodiments, the spent lithium cathode material and particulate lithium source are mixed by milling particles of the lithium cathode material and particulate lithium source.

In some embodiments, the particulate lithium source can include a particulate lithium salt, such as LiNO₃.

In some embodiments, the spent lithium cathode material is selected from spent LiCoO₂ (LCO), LiMn₂O₄ (LMO), LiFePO₄ (LFP), LiNiMnCoO₂ (NMC), LiNiCoAlO₂ (NCA) or mixtures thereof.

Other embodiments described herein relate to a relithiated cathode material formed by the method 10. The relithiated cathode material can have a specific capacity, cycling performance, and/or rate capability substantially equal to or better than specific capacity, cycling performance, and/or rate capability of pristine cathode material.

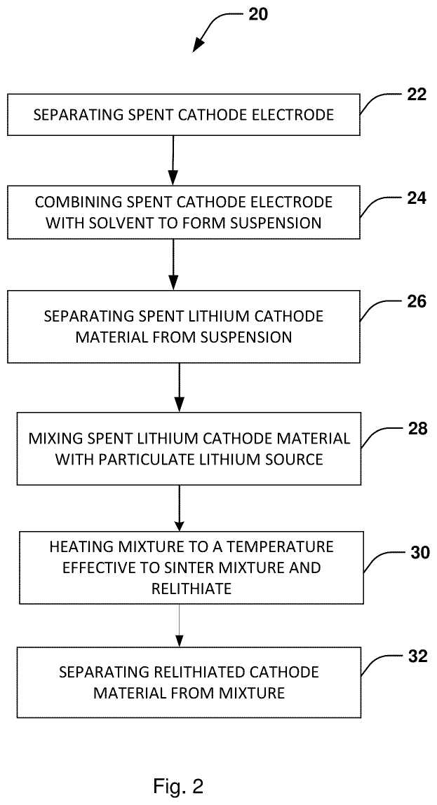

FIG. 2 illustrates a method 20 of recycling and/or recovery of cathode materials from a spent lithium ion battery in accordance with another embodiment described herein. The method 20 at step 22 includes separating a cathode electrode from the spent lithium ion battery. At step 24, the spent cathode electrode is combined with a solvent to form a suspension comprising spent lithium cathode material. At step 26, the spent lithium cathode material is separated from the suspension. At step 28, the spent lithium cathode material is mixed with a particulate lithium source. At step 30, the mixture is heated to a temperature effective to sinter the mixture and relithiate the spent lithium cathode material. At step 32, the relithiated cathode material is separated or isolated from the mixture.

In some embodiments, the method 20 can further include preheating the mixture to a temperature below the sintering temperature prior sintering. For example, the mixture can be preheated at a temperature of about 140° C. to about 160° C. for a first duration of time and sintered at a temperature of about 300° C. to about 350° C. for a second duration of time. The second duration of time can be substantially longer than the first duration of time.

In some embodiments, the relithiated cathode material can be milled after sintering to prevent agglomeration.

In some embodiments, the spent lithium cathode material and particulate lithium source are mixed by milling particles of the lithium cathode material and particulate lithium source.

In some embodiments, the spent cathode electrode is separated from spent lithium ion battery by removing the spent cathode electrode from the spent lithium ion battery in an inert atmosphere and soaking the removed spent cathode electrode in a solvent to remove residual electrolyte from the cathode electrode.

In some embodiments, the solvent combined with spent cathode electrode to form the suspension includes N-methyl-2-pyrrolidone.

In some embodiments, the particulate lithium source can include a particulate lithium salt, such as LiNO₃.

In some embodiments, the spent lithium cathode material is selected from spent LiCoO₂ (LCO), LiMn₂O₄ (LMO), LiFePO₄ (LFP), LiNiMnCoO₂ (NMC), LiNiCoAlO₂ (NCA) or mixtures thereof.

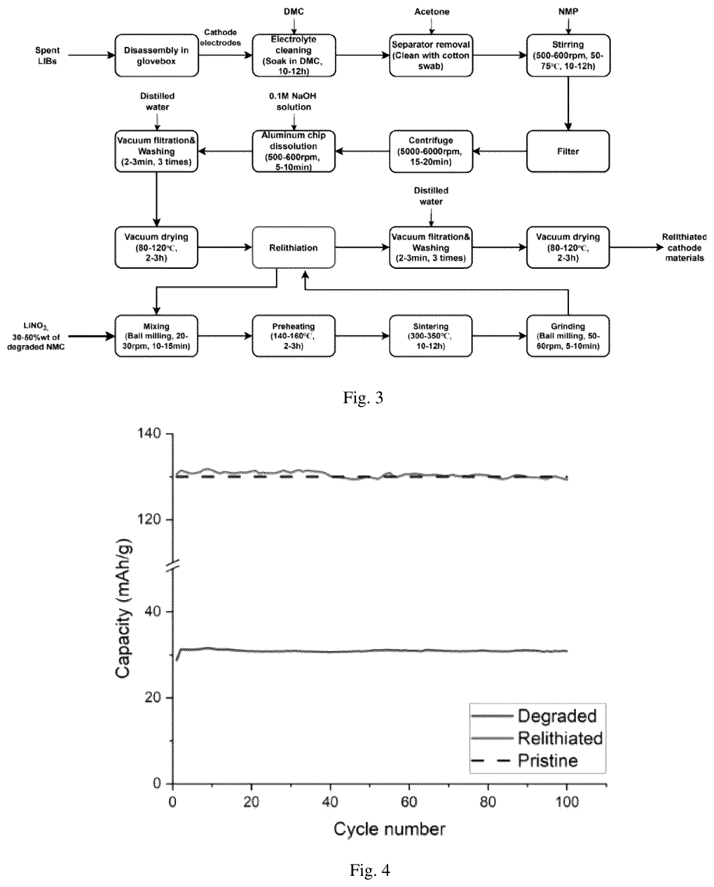

FIG. 3 is the flowchart of the direct recycling method of spent cathode active materials in accordance with another embodiment described herein. The spent lithium ion batteries are pouch cells (version, LGX P1.5B) manufactured by LG Chem Ltd. The cathode active materials are a mixture of NMC111 and LMO with a weight ratio of 3:1. The spent lithium ion batteries are disassembled in the glovebox and separated into cathode and anode. The cathode electrodes are sealed in the glovebox and moved outside of the glovebox. The cathode electrodes are soaked into the DMC for 10-12 h to remove the remaining electrolyte on the surface of the electrodes. The electrodes are cleaned with acetone and cotton swabs to remove the remaining separator pieces. The electrodes are immersed into excessive NMP and stirred at 500-600 rpm for 10-12 h. The temperature of the stirring process can be from 50° C. to 75° C. The suspension is filtered to remove the aluminum foil pieces. The suspension is centrifuged at 5000-6000 rpm for 15-20 min to separate the NMP and spent cathode materials. The liquid layer is removed and the solid content is dispersed into 0.1M NaOH solution stirring at 500-600 rpm for 5-10 min to further remove the remaining aluminum pieces. The suspension is transferred to the vacuum filtration system and the cathode materials on the filter are washed with distilled water for 2-3 min 3 times. The cathode materials are transferred to the vacuum oven and dried at 80-120° C. for 2-3 h. In the relithiation process, the spent cathode active materials are mixed with LiNO₃ in the ball milling machine at 20-30 rpm for 10-15 min, and the weight of LiNO₃ is 30-50% of the weight of spent cathode active materials. The mixture is transferred to the oven to relithiate and recover the spent cathode active materials. The mixture is preheated at 140-160° C. for 2-3 h, and then the temperature increases to 300-350° C. to sinter the mixture for 10-12 h. The relithiated materials are ground in the ball milling machine at 50-60 rpm for 5-10 min to avoid agglomeration. The materials are dispersed into distilled water to dissolve the remaining LiNO₃, and the suspension is transferred to the vacuum filtration system for the washing process. The relithiated material is washed for 2-3 min by 3 times. The solid on the filter is dried in the vacuum oven at 80-120° C. for 2-3 h to obtain the pure relithiated cathode active materials.

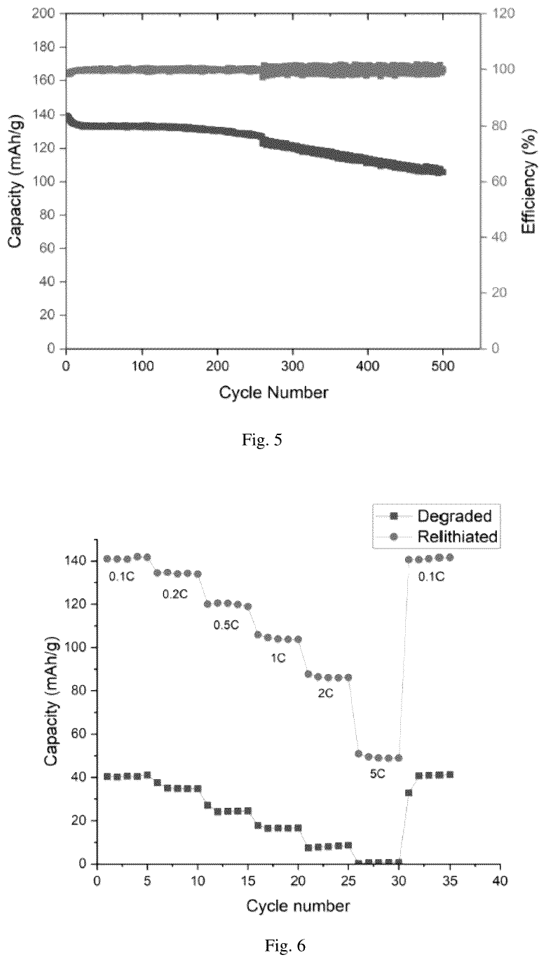

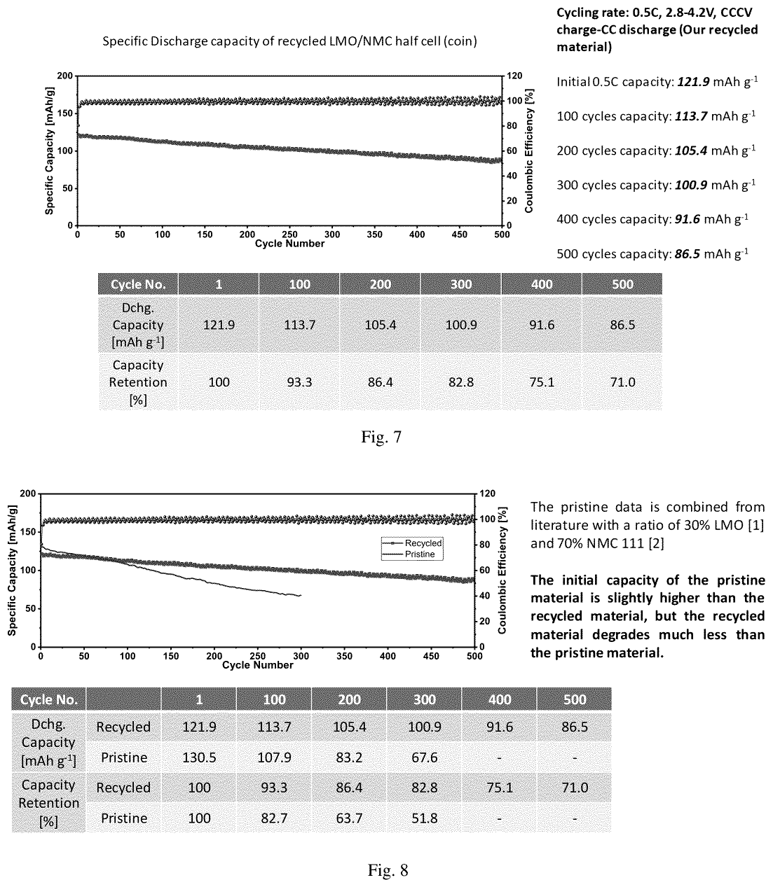

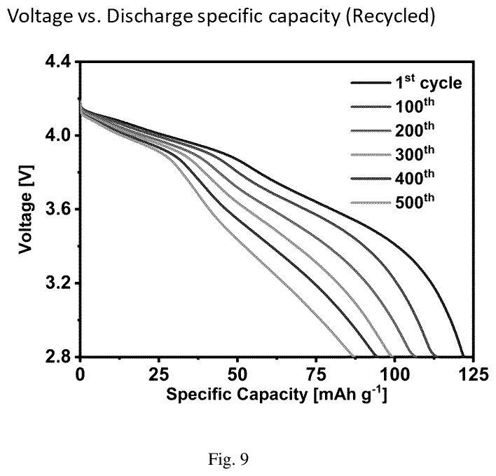

The final product is the relithiated cathode active materials with fine particles. The electrochemical performance is tested by the Neware battery tester (Neware Ltd, China). The specific capacity, cycling performance are shown in FIG. 4, the long-term cycling performance at 1C is shown in FIG. 5, and rate capability results are shown in FIG. 6. FIG. 7 illustrates the discharge capacity of recycled LMO/NMC half cell (coin). FIG. 8 illustrates difference and degradation in pristine material vs. recycled material. FIG. 9 illustrates the voltage vs. discharge specific capacity in the recycled batteries.

The cycling performance is tested at a current density of 0.5C, the long-term cycling performance is tested at a current density of 1C and the rate capability is tested at current densities of 0.1C, 0.2C, 0.5C, 1C, 2C, and 5C. The specific capacity of the spent cathode active material is about 30 mAh/g. After the direct recycling process, the specific capacity comes back to 130 mAh/g at 0.5C, which is consistent with the specific capacity of pristine blend cathode of LMO and NMC. Besides, the relithiated materials possess an outstanding rate capability after the direct recycling process. Thus, the direct recycling method proposed in this patent can recover the structure and capacity with one sintering step, and the relithiated cathode active materials can be directly reused in the manufacturing of new lithium ion batteries.

The application of this method can be extended to most of the dominant cathode materials, including LCO (LiCoO₂), LMO (LiMn₂O₄), LFP (LiFePO₄), high nickel NMC (LiNiMnCoO₂), and NCA (LiNiCoAlO₂). To enhance the stability of long-term cycling performance of relithiated cathode materials, short annealing and tempering processes will be added to the relithiation processes. A coating process is also considered a potential process to eliminate the side reaction of relithiated cathode materials with liquid electrolytes during charging and discharging. The coating materials can be Al₂O₃, TiO₂, Zn, Al pristine NMC (LiNiMnCoO₂), etc.

Particle size is also a significant parameter that affect the electrochemical performance of recycled cathode active materials. Therefore, high-speed ball milling and grinding processes will also be integrated in the recycling processes to control the particle size and avoid the agglomerate caused by the sintering process.

From the above description of the invention, those skilled in the art will perceive improvements, changes and modifications. Such improvements, changes and modifications within the skill of the art are intended to be covered by the appended claims. All references, publications, and patents cited in the present application are herein incorporated by reference in their entirety.

Having described the invention, we claim:

1. A method of relithiating a spent cathode material from a spent lithium ion battery, the method comprising:
mixing the spent lithium cathode material with a particulate lithium source; and
heating the mixture to a temperature effective to sinter the mixture and relithiate the spent lithium cathode material.

2. The method of claim 1, further comprising preheating the mixture to a temperature below the sintering temperature prior to sintering.

3. The method of claim 2, wherein the mixture is preheated at a temperature of about 140° C. to about 160° C. for a first duration of time and sintered at a temperature of about 300° C. to about 350° C. for a second duration of time.

4. The method of claim 3, wherein the second duration of time is substantially longer than the first duration of time

5. The method of claim 4, further comprising milling the relithiated cathode material after sintering to prevent agglomeration.

6. The method of claim 1, further comprising separating relithiated cathode material from the mixture.

7. The method of claim 1, wherein the spent lithium cathode material and particulate lithium source are mixed by milling particles of the lithium cathode material and particulate lithium source.

8. The method of claim 1, wherein the particulate lithium source comprise a particulate lithium salt.

9. The method of claim 1, wherein the spent lithium cathode material is selected from spent LiCoO₂ (LCO), LiMn₂O₄ (LMO), LiFePO₄ (LFP), LiNiMnCoO₂ (NMC), LiNiCoAlO₂ (NCA) or mixtures thereof.

10. A relithiated cathode material formed by the method of claim 1.

11. The relithiated cathode material of claim 10, having a specific capacity, cycling performance, and/or rate capability substantially equal to or better than specific capacity, cycling performance, and/or rate capability of pristine cathode material.

12. A method of recycling and/or recovery of cathode materials from a spent lithium ion battery, the method comprising:
separating a cathode electrode from the spent lithium ion battery;
combining the spent cathode electrode with a solvent to form a suspension comprising spent lithium cathode material;
separating the spent lithium cathode material from the suspension;
mixing the spent lithium cathode material with a particulate lithium source;
heating the mixture to a temperature effective to sinter the mixture and relithiate the spent lithium cathode material; and
separating the relithiated cathode material from the mixture.

13. The method of claim 12, further comprising preheating the mixture to a temperature below the sintering temperature prior sintering.

14. The method of claim 13, wherein the mixture is preheated at a temperature of about 140° C. to about 160° C. for a first duration of time and sintered at a temperature of about 300° C. to about 350° C.

15. The method of claim 12, further comprising milling the relithiated cathode material after sintering to prevent agglomeration.

16. The method of claim 12, wherein the spent lithium cathode material and particulate lithium source are mixed by milling particles of the lithium cathode material and particulate lithium source.

17. The method of claim 12, wherein the spent cathode electrode is separated from spent lithium ion battery by:
removing the spent cathode electrode from the spent lithium ion battery in an inert atmosphere; and
soaking the removed spent cathode electrode in a solvent to remove residual electrolyte from the cathode electrode.

18. The method of claim 12, wherein the solvent combined with spent cathode electrode to form the suspension includes N-methyl-2-pyrrolidone.

19. The method of claim 12, wherein the particulate lithium source comprise a particulate lithium salt.

20. The method of claim 12, wherein the spent lithium cathode material is selected from spent LiCoO₂ (LCO), LiMn₂O₄ (LMO), LiFePO₄ (LFP), LiNiMnCoO₂ (NMC), LiNiCoAlO₂ (NCA) or mixtures thereof.
